(19) United States
(12) Patent Application Publication
(10) Pub. No.: US 2003/0187989 A1
(43) Pub. Date: Oct. 2, 2003

(54) System and method for determining memory usage in sizing a portal server

(76) Inventor: Patrick Petit, Grenoble (FR)

Correspondence Address: WAGNER, MURABITO & HAO LLP, Third Floor, Two North Market Street, San Jose, CA, 95113, US

(21) Appl. No.: 10/108,123

(22) Filed: Mar. 27, 2002

(51) Int. Cl. G06F 15/16

(52) U.S. Cl. 709/227; 709/229

(57) ABSTRACT

In an enterprise portal server system having a server, a web-based memory sizing method and system. The memory sizing system includes logic for determining primary performance metrics that may affect the performance of a portal server. The memory sizing system further includes a logic for gathering secondary sizing factors that may also impact the performance of the portal server. In one embodiment of the present invention, a maximum number of concurrent user that may connect to the portal server together with the average session time of user accesses to the portal server, the maximum desktop reloads of desktop connecting to the portal server and the maximum number of initial desktop displays are used to determine the optimal number of memory required for optimum performance which means maximum throughput for minimum transaction time of the portal server.

### CROSS REFERENCE TO RELATED APPLICATION

This application is related to Patrick Petit et al., co-filed U.S. patent application Ser. No. ,______, filed on ______, titled “SYSTEM AND METHOD OF DETERMINING THE NUMBER OF CENTRAL PROCESSING UNIT FOR SIZING A PORTAL SERVER ”, attorney docket No.: SUN/P7147/ACM/DKA. To the extent not repeated herein, the contents of this patent application are hereby incorporated herein by reference.

### FIELD OF THE INVENTION

The present claimed invention relates generally to the field of corporate enterprise portal server systems. More particularly, embodiments of the present claimed invention relate to sizing the performance of portal servers.

### BACKGROUND ART

The Internet has become a dominant vehicle for data communications with a vast collection of computing resources interconnected as a network from sites around the world. And with the growth of Internet usage has come a corresponding growth in the usage of Internet devices, wireless devices and services in ways different from the traditional uses of such devices.

The growing base of Internet users has become accustomed to readily accessing Internet-based services, which traditionally were restricted or limited to the “client/server” environment, at any time from any location. Accessibility of traditional business services and products over the Internet means enterprises need to adjust to new paradigms of business transaction.

Consequently, some organizations are, for example, implementing a variety of business resources and services. As businesses migrate to implementing numerous business applications on the Internet and web-based applications become pervasive in the enterprise business environment, businesses must find ways to protect their valuable resources and services over the Internet.

To achieve this, business are implementing several access authentication schemes in order to ascertain valid user access to such resources over the Internet. To access protected resources or services, users within a typical business enterprise environment must authenticate themselves to access web-based resources.

To facilitate these security measures, business organizations are making a transition from unsophisticated network infrastructure to a sophisticated network infrastructure. Additionally, portal services are becoming an essential part of today's network-centric computing infrastructure. In making such a transition, efficient management of services and resources offered by such intelligent networks become critical. Today, many organizations have mission critical applications for users and policies on individually configurable desktop machines. This time-consuming individual configuration process is unsuitable for enterprises and service providers seeking to create intelligent networks.

User management and policy based tools for managing services are becoming an important requisite for intelligent networks which should be capable of dynamically providing services. Furthermore, as businesses extend their intranet services to extranets to include suppliers, business partners, and customers, providing access control increases in size and complexity. Organizations responding to the rapidly changing conditions of today's business environments, need to simplify and automate the configuration and control of their services.

In making corporate services available to a large number of employees and customer base, security of the information provided by corporations becomes critical. As corporate security takes the forefront of corporate computing, the use of virtual private networks has become an indispensable part of corporate networks.

A virtual private network is a way to simulate a private network over a public network such as the Internet. The growth in the Internet and its popular information services, commonly known as the World Wide Web, has led to a popularity in the use of corporate intranets. Internally, companies are running TCP/IP networks (intranets) pushing information to their internal web-sites using web browsers as a common collaborative tool.

VPNs can be used to expand the reach of an intranet. Since intranets are typically used to communicate proprietary information, a company may not want just anyone on the Internet to have access to the information. There may be cases, however, where the company may want far-off offices to share data and information or for remote users to be able to connect to the company's intranet with corporate users using the Internet as a means of connection.

The need to share data within and outside the company's internal network has also led to the popularity in community web-based or portals to share community based data, applications, service, etc., by a variety of user groups within a company. The increasing using of such community based data sharing has led to the increasing use of portal servers that connect the variety of user base to the corporate intranet and the Internet.

Portal servers provide a secure way of connecting the corporate intranet to the Internet thereby reducing the fears that sensitive information might leave the corporate network. A portal server also provides users the ability to connect to a corporate intranet via, the Internet using a web browser without the user having to reconfigure their computer. The ease in connecting to corporate intranets via the portal server has made portal servers very attractive to many corporate information systems decision makers.

FIG. 1 is a block diagram illustration of a portal server environment. The portal server environment depicted in FIG. 1 comprises an enterprise portal server 110, a public network (the Internet) 115, a corporate intranet 120, back-end resource servers 130-140 and client computers 145-150. In the environment depicted in FIG. 1, client users 145-150 can directly access each of applications residing in the portal server 110 via the Internet 115 if such users are at a remote location. Similarly client 155 can access the same applications on the portal server 110 via the internal corporate intranet 120. Access to applications in the portal server 110 is subject to the user being authenticated by each individual application.

In the environment depicted in FIG. 1, for the user to access protected resources or services, the user must authenticate. If the user authenticates successfully and if the user is authorized to access the resources, the user is given access to the resource. User access is subject to the user presenting a valid password specific to each application in order to access the particular application.

Since the portal server 110 may be accessed from a variety of venues (e.g., remotely or directly) the number of users accessing the portal server at any point in time can be very large. The number of users concurrently connecting or attempting to connect to the portal server 110, may impact the performance of the portal server 110. To ensure the optimal performance of the portal server 110, system administrators typically manually determine a way to increase the size of the memory usage in the portal server 110 to allow a larger connected user base. However, these manual memory size increases are done without any precise logic or formula to it. Thus, most of these memory usage performance sizing of the portal server 110 are done on manual trial and error basis. This can be an inefficient and ineffective way to increase the performance of the portal server 110.

### SUMMARY OF INVENTION

Accordingly, in order to prevent the undue performance burdens that current portal users frequently encounter as they remotely or directly access network applications from portal servers via the Internet or intranet, there should be a way to for system administrators to automatically determine certain performance metrics to enhance memory sizing requirements of the portal server. There must also be a way to allow the user to access multiple applications in the portal server without experiencing performance delays due to a lack of appropriate performance metrics being implemented by the port server as a result of ineffective and inefficient performance sizing methods.

As the number of business applications on the Internet increases, enterprise system users are looking for an easy and reliable way to access multiple applications in a web based application environment without the inefficiencies of the prior art. An Internet infrastructure system is needed that has extensibility capabilities to allow access authentication and authorization to web-based resources and services in a business enterprise environment. Further, a need exists for a system and method of tracking user access to network resources and application services in order to provide optimal server service within a business environment. A need further exists for “out-of-the-box” central processing sizing solutions to allow network system administrators to connect portal servers to existing corporate networks that have the capacity to support a large number of users without the attendant performance problems of the prior art. A need further exists for an improved and less costly device independent portal server system, which improves efficiency and provides access to web-based content to various users of different configurations without losing the embedded features designed for these devices.

What is described, in one embodiment, is a memory usage determining system and method having a portal server supporting a memory sizing tool for determining the optimal memory usage to enhance the performance of the portal server. This system provides access to predetermined primary metrics and secondary resources and services in a corporate portal server system environment to generate the appropriate metrics to size the portal server. In one embodiment of the present invention, the portal server system includes an authentication service system that authenticates user access requests to the portal server. A user access request is typically directed to web-based software applications and services which may be specific to an organization or an entity. In one embodiment of the present invention, the authentication service system additionally includes a user agent policy system that sets user access policy to applications in the portal server.

The present invention further includes a session service that monitors a user's session after the user has been authenticated to access particular files or directories in the portal server. The session service provides the present invention the ability to bypass user re-authentication after the user has been initially authenticated and validated.

Embodiments of the present invention are directed to a system and a method for determining the optimal memory size for enhancing the performance of the portal server in light of the number of concurrent users who connect to the portal server. The present invention uses primary sizing factors such as the maximum number of users that can connect to the portal server, the maximum number of concurrent users that may connect to the portal server at a particular point in time.

Embodiments of the present invention include a memory sizing module that is implemented as part of the portal server modules in an enterprise server system environment. The memory module includes logic that allows a system administrator determine the optimal memory usage size to enhance the optimal performance of the portal server.

Embodiments of the present invention include a performance requirements assessment module. The performance requirements assessment module provides the primary performance sizing metrics required to determine the memory size required by the portal server. The performance requirements assessment module gathers performance metrics such as the maximum number of connected users that may connect to the portal server.

Embodiments of the performance requirements assessment module of the present invention further include a concurrent user calculation module. The concurrent user calculation module calculates the maximum number of users that may concurrently connect to the portal server at any particular point in time and establishes a session during a user authentication sequence so that the user can be identified across different requests made to the server.

Embodiments of the present invention further include a secondary sizing factors assessment module. The secondary sizing factors assessment module gathers secondary factors that may affect the sizing of the portal server in determining the optimal memory usage size the portal server may require. These secondary factors may include the desktop configuration of desktop or wireless computers that may connect to the portal server. The secondary sizing factors may further include desktop reload data that indicate the number of reloads that users connected to the portal server may perform.

Embodiments of the present invention further include a profile service module that tracks user profile access of URLs in the server. Embodiments of the present invention also include a URL access service that uses an extensible markup language (XML) over a hypertext transport protocol (HTTP) interface of the authentication-service and profile services, respectively, to validate a user's request. The URL access service validates a user's credentials thereby enforcing the user's URL access policy to resources and applications in the portal server.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

FIG. 1 is a block diagram of a portal server environment of the prior art;

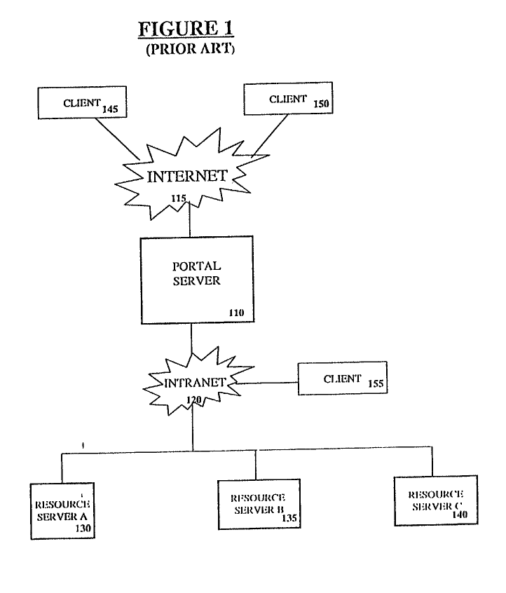

FIG. 2 is a block diagram of one embodiment of the portal server environment of the present invention;

FIG. 3 is a block diagram of one embodiment of the portal server of the present invention;

FIG. 4 is a block diagram of an embodiment of the architecture of the Memory usage determination tool system of the present invention;

FIG. 5 is a block diagram of one embodiment of the performance requirements assessment module of FIG. 4; and

FIG. 6 is a flow chart of one embodiment of an exemplary process flow of the memory usage sizing process of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the-invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

Embodiments of the invention are directed to a system, an architecture, subsystem and method to determine the optimal memory usage size required by a portal server for optimum performance of maximum throughput with minimum transaction time in a way superior to the prior art.

In the following detailed description of the present invention, a system and method for an Internet protocol-based resource and applications access system are described. Numerous specific details are not set forth in order to provide a thorough understanding of the present invention. However, it will be recognized by one skilled in the art that the present invention may be practiced without these specific details or with equivalents thereof.

Generally, an aspect of the invention encompasses providing a memory usage sizing system which provides a method of determining the optimal memory usage size a portal server may require during a deployment of a portal server in an enterprise network system.

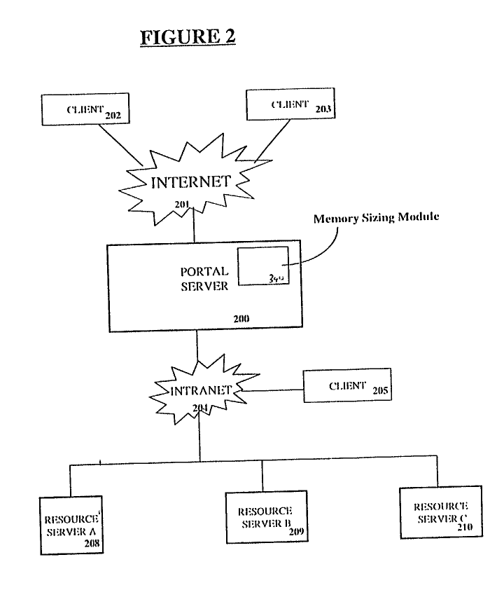

FIG. 2 is a block diagram illustration of a portal server environment. The portal server environment depicted in FIG. 2 comprises a portal server 200, a plurality of desktop or wireless clients 202 and 203 which are connected to the Internet 201, intranet 204, client 205 and back-end resource servers 208-210. In the environment depicted in FIG. 2, a user can directly access the portal server 200 either via the Internet 201 or the intranet 204. As further depicted in FIG. 2, the portal server 210 comprises a memory sizing unit 340 of the present invention. Access to URLs in applications on the portal server 200 is subject to the user being authenticated by the portal server 200.

In the environment depicted in FIG. 2, for the user to access protected resources or services, the user must authenticate. If the user authenticates successfully and if the user is authorized to access the resources, the user is given access to the resource. Content provided by the portal server 200 may include content aggregated from the back-end resource servers 208-210. In the environment shown in FIG. 2, the portal server 200 tracks the initial desktop displays after the client has authenticated to the portal server 200 and the desktop reloads in order to generate the right metrics to measure the throughput of the portal server 200.

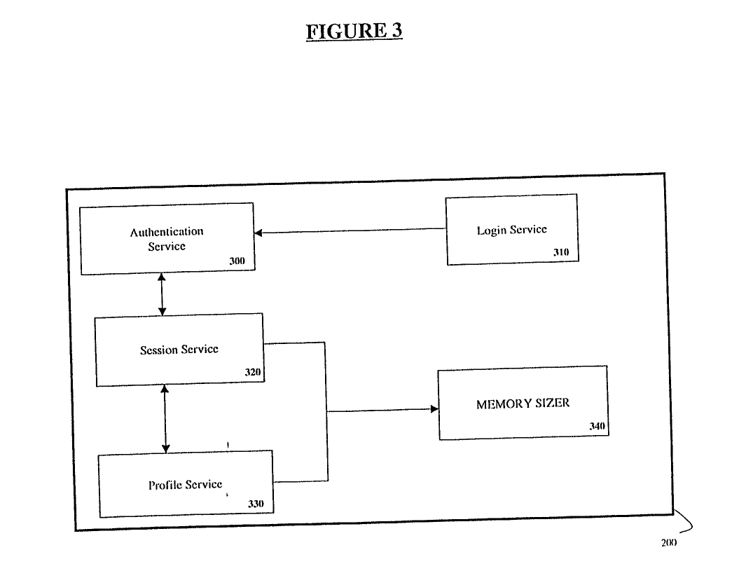

FIG. 3 is a block diagram depiction of one embodiment of the portal server 200 of the present invention. In the exemplary diagram shown in FIG. 3, the portal server 200 comprises authentication module 300, login module 310, session module 320, profile module 330 and memory sizing module 340.

The authentication module 300 provides sign on service authentication of the present invention. The authentication module 300 provides the portal server 200 (FIG. 2) with the logic and option to protect Internet software applications and services-from unauthorized authenticated users of these applications.

The authentication module 300 of FIG. 3 further provides the portal server 200 with the access implementation logic to selectively allow access to specified applications and services within enterprise organizations. By selectively allowing only authorized and authenticated users access to particular files within an organizations file database, the authentication module 300 ensures that corporate enterprise resources are efficiently and effectively utilized.

Further, the authentication module 300 allows authenticated users of the portal server 200 access to continuous and uninterrupted use of resources and applications available on the server 200. This enables the sizing logic of the present invention to accurately determine the number of users that are connected to the portal server 200 at any time.

The login module 310 provides login services to the portal server 200. Login module 310 includes logic to enable the tracking of a user's password to enable the sign-on services of the authentication process to function in the server 200.

Still referring to FIG. 3, the session module 320 provides a session tracking mechanism to enable the authentication logic of the present invention to track a user's login session to the portal server 200. The session module 320 logs the user's access of each application for which the user is authenticated to access. By logging the user's access to applications on the portal server 200, the authentication module is able to automatically authenticate the user's access to subsequent applications, after the initial login, without requiring a separate manual re-login.

The profile module 330 provides user profile information to the authentication module 300. The profile module 330 provides an XML over http(s) interface for obtaining user, service and policy information. A user's profile information typically includes the user-name, the user's password and the user's entity within a particular organization.

The profile information further defines the user's application access rights which determine or set forth user's rights to files and directory within applications and resources in portal server 200.

The memory sizing module 340 is coupled to provide the memory sizing process of the present invention. The memory sizing module 340 includes logic to monitor the number of users connected to the portal server 200, the maximum number of concurrent users connected to the portal server 200 and other secondary factors associated with the portal server 200 to determine performance metrics to enhance the performance of the portal server 200. The memory sizing module 340 provides a mechanism by which a system administrator can determine the memory size that a particular portal server may need to provide an efficient and effective utilization of the underlying portal resources by the users connected to the portal server. Additionally, one embodiment of the present invention is able to use the memory sizing process to determine the optimal number of central processing units the portal server 200 may require.

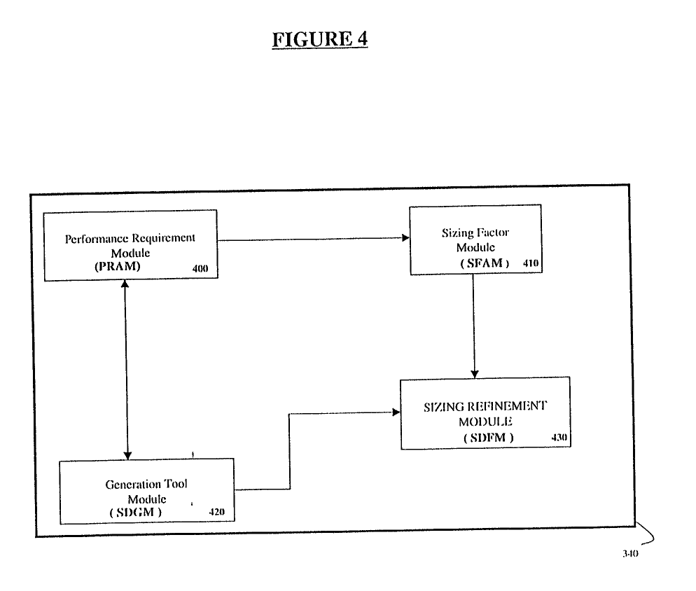

FIG. 4 is a block diagram illustration of an internal architecture of one embodiment of the memory sizing module 340 of the present invention. As shown in FIG. 4, the memory sizing module 340 comprises performance requirements assessment module (PRAM) 400, secondary factors sizing assessment module (SFAM). 410, sizing data generation module (SDGM) 420 and sizing data refinement module (SDFM) 430. In order to determine the memory usage sizing requirements of the portal server 200, the memory sizing module 340 executes in sequence the sizing modules depicted in FIG. 4 to best determine the optimal memory use for a specific deployment of the portal server 200.

To accomplish the sizing process of the present invention, the memory sizing module 340 initiates a performance requirement data gathering process by activating PRAM 400 to gather and assess data metrics provided by a system administrator based on the computing environment of the particular portal server 200. The data provided by the system administrator enables the PRAM 400 generate the correct formulation of the maximum number of users that may connect to the portal server 200 and the maximum number of concurrent users who may connect to the portal server 200 at any time.

SFAM 410 provides the PRAM 400 with secondary data that may factor into the performance metrics that PRAM 400 generates and assesses to determine the optimum number of CPUs the portal server 200 may require. SFAM 410 gathers and assesses secondary performance metrics that may be required by the portal server 200 to complete the sizing process of the present invention.

Among the-secondary factor metrics that SFAM 410 may gather and assess include the desktop configuration of the users who may connect to the portal server 200, the specific customization metrics, if any, of a particular portal server, the average session times that users login into the portal server and, the server hardware and applications configurations that may affect the performance of the portal server. The speed and efficiency parameters of the back-end resources servers 208-210 that connect to the portal server 200 are also gathered and assessed by SFAM 410. The data gathered by SFAM 410 are used as inputs in the sizing process by memory sizing module 340.

Still referring to FIG. 4, the SDFM 430 provides a pilot representation data of the final portal server application in order to validate and refine the sizing numbers obtained in an initial run of the sizing process of the present invention. Since performance and resource consumption vary greatly in a particular portal server depending on the complexity of the connecting desktops and usage profile, the memory sizing process of the present invention provides a mechanism for the system administrator to generate a sample (pilot) of the contemplated sizing metrics of a portal server being sized before fully implementing the memory sizing module 340.

The SDFM 430 implements a representative subset of the portal applications that typically will run on portal server 200 by integrating back-end services of the back-end resource server 208-210 to generate a subset of the projected memory size that may be obtained during a full implementation of the sizing process. The numbers from the pilot performance test using the pilot numbers provided by the SDFM 430 is re-injected into the memory sizing module 340 to obtain a more accurate result during a full implementation of the sizing metrics gathered by the memory sizing module 340.

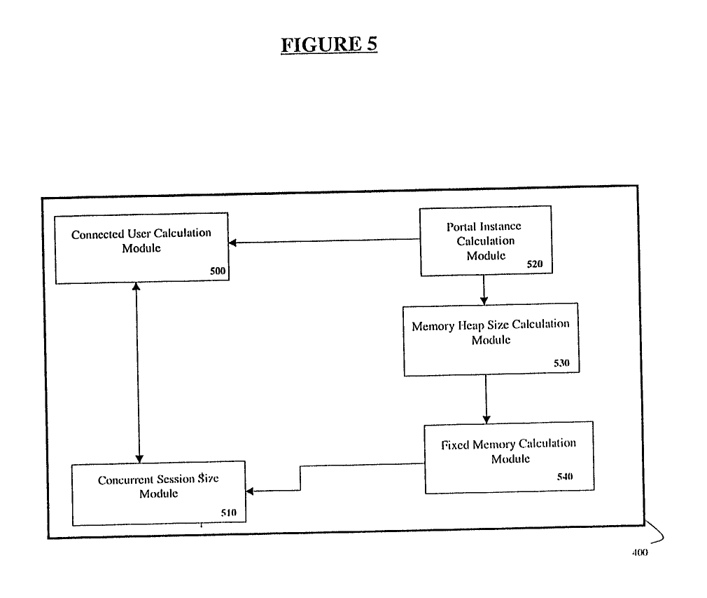

FIG. 5 is block diagram depiction of one embodiment of the performance requirement assessment module 400 of the present invention. The performance requirement assessment module 400, as shown in FIG. 5, comprises connected user calculation module 500, concurrent session size calculation module 510, portal instance calculation module 520 and a fixed memory calculation module 530.

The connected user calculation module 500 calculates the maximum number of users or sessions connected to the portal server 200. A connected user is a user who has a valid portal session open, but who may not be active at a certain time. The maximum number of users is generally a percentage of the user base that can be obtained from different sources, such as usage statistics or web traffic analysis for an already existing portal or web application.

The web traffic metric representing the best value to determine the maximum number of connected users is often referred to as visitor sessions (e.g., a single visitor visit within a predefined period of time). Depending on the portal audience and portal type (e.g., business to employee or business to customer portal), that percentage can vary from a fraction of the user base to the entire user base. For example, in a corporate environment, the total user base may be based on the number of active employees, not including employees that are either on the road, on vacation, or are out sick.

In the present invention, another variable that needs to be considered to calculate the maximum number of connected users by the connected user calculation module 500 is whether the calculated maximum number of connected users was calculated based on regular or peak server load conditions. The periodicity and amplitude of the peaks of load can substantially vary over time, but once they have been identified, the resulting number of connected users tends to be relatively steady for an observed period.

The average portal session size calculation module 510 is coupled to the connected user calculation module 500 to calculate the maximum average number of concurrent sessions that may be opened to the portal server 200 at any time. To calculate the average portal sessions size, the average portal session size the process size calculation module 510 calculates for a number of sessions to in order determine the average session size for one session.

The session size determines the memory footprint of the portal server 200. The more active sessions, the larger the amount of data held in memory and the more instances the portal server 200 generates. The amount of data held in memory of a portal session is incrementally proportional to the amount and types of channels configured in the desktops connecting to the portal server 200.

In one embodiment of the present invention, the number of active sessions held in memory is driven by the number of connected users to the portal server 200. The portal instance calculation module 520 calculates the number of portal instances per central processing units of the portal server 200.

Still referring to FIG. 5, the fixed memory calculation module 530 is coupled to the connected user calculation module 500 and session size module 510 to determine the portal server applications that are provided by the portal server 200. Since each portal application provided by the portal server 200 consumes some amount of memory, it is imperative for the total amount of memory consumed by these applications be accounted for. This is especially true for the case where the system administrator is implementing a large portal server deployment that may require multiple instances per node.

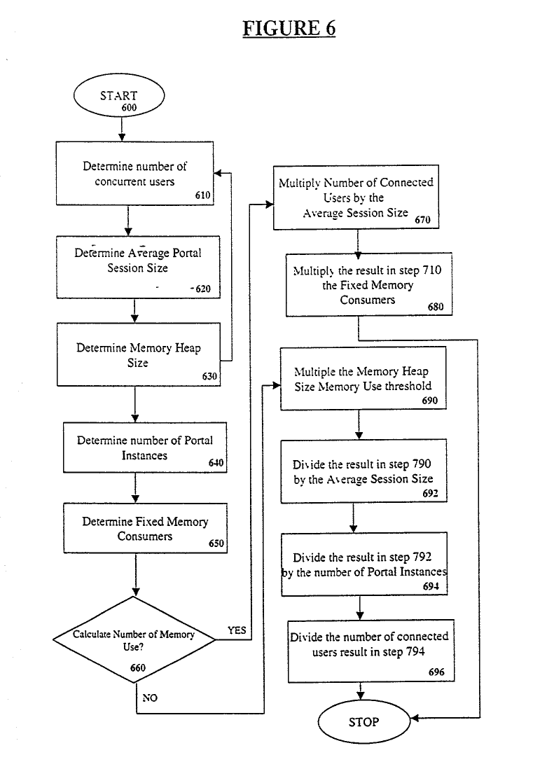

FIG. 6 represents a flow diagram depiction of an exemplary computer implemented process in accordance with one embodiment of the memory sizing processing of the present invention. The steps performed by the diagram of FIG. 6 are performed by a computer system processor executing memory stored instructions which make up a program or application. The memory usage size in the portal server 200 is primary determined by the number of HTTP operations (or transactions) generated by all the concurrent users per unit of time. Typically, HTTP operations to the portal server 200 are a mix of get and post requests to the underlying servlet engines for creating portal sessions, initializing desktops and desktop reloads, or simply to static HTML and GIF files.

As shown in FIG. 6, the processing of the portal server 200 memory sizing is initiated at step 600 when a system administrator's sizing request is presented to the memory sizing module 340. At step 610, the memory sizing module 340 determines the average number of connected users of the portal server 200. This number is obtained from the performance requirements module 400.

At step 620, the memory sizing module 340 determines the average portal session size. The average portal session size includes the average number of active portal sessions held in memory of the portal server 200. The number of active sessions is typically driven by the number of connected users connected to the portal server 200.

At step 630, the memory sizing module 340 determines the memory heap size. In one embodiment of the present invention, the memory heap size may be set to one gigabyte.

At step 640, the memory sizing module 340 determines the number of portal instances in the portal server 200. In one embodiment of the present invention, the number of portal instances in the portal server 200 depends on the number of central processing units available in the portal server 200.

At step 650, the memory sizing module 340 determines the fixed memory consumers in the portal server 200. The amount of fixed memory consumed in the portal sever 200 depend on the number of applications that runs in the portal server 200. Examples of these fixed memory consumers may include applications such as directory service, authentication service, etc.

At step 660, the memory sizing module 340 is able to determine whether to calculate the number of CPUs that the portal server 200 may require using a memory usage calculation method or the global amount of memory that the portal server 200 may need during a portal server deployment. If the service required by the memory sizing method is to calculate the number of CPUs that the portal server 200 may require, the memory sizing module 340 proceeds to step 690. If, on the other hand, the memory sizing module 340 is calculating the global memory requirements for the portal server 200 during a portal server deployment, then processing continues at step 670 where the number of concurrent users is multiplied by the average session size.

At step 680, the result of step 670 is added to the memory size of the fixed memory consumers. At step 690, the memory sizing module 340 calculates the number of CPUs that the portal server may require using a memory usage calculation process of the present invention. The memory sizing module 340 multiplies the memory heap size by a memory size threshold.

In one embodiment of the present invention, the memory size threshold is determined by the percentage of users that may connect to the portal server 200 during peak hours out of the total possible number of users that may connect to the portal server at any given time. In one embodiment of the present invention, the heap memory size may be set to one gigabyte.

At step 692, the results from step 690 is divide by the average session size. And at step 694, the results of step 692 is divided by the number of portal instances.

The memory sizing module 340 use the following formula to determine the memory usage for sizing the portal server 200:

mem#=(ssa * memory threshold)+FM

Where

mem#: is the memory usage size;

ssa: is the average portal session;

FM: is the fixed memory size; and

memory threshold: is the percentage of users connected to the portal server during peak usage out of the total number of users that may connected to the portal server.

In one embodiment of the present invention, the memory sizing process determines the number of CPUs required by the portal server 200 based on the available memory by dividing the number of connected users with the result in step 694. The current CPU sizing of one embodiment of the present invention may thus be expressed by the following formula expression:

#cpu=cnu/((hps * memory threshold)/ssa)/ipc)

where:

cnu:—is the maximum number of connected users;

hps:—is the JVM heap size;

ssa:—is the average portal session;

ip:—is the number of portal instance per CPU; and

memory threshold: is the percentage of users connected to the portal server during peak usage out of the total number of users that may connected to the portal server.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A portal server, comprising:
an authentication module for authenticating user credentials for users attempting to connect to said portal server;
a session module coupled to said authentication module to monitor authenticated user access to said portal server;
a profile module coupled to said session module to store user profile information for each user successfully authenticating to said portal server; and
a memory sizing module for determining the optimal amount of memory required by said portal server for optimum performance.

2. The portal server of claim 1, wherein said memory sizing module comprises a performance requirement assessment and analysis module for gathering performance measurement metrics to calculate the optimal memory sizing performance of said portal server.

3. The portal server of claim 2, wherein said performance requirements assessment and analysis module further comprises a connected user calculation module for calculating the maximum number of concurrent users that may connect to the portal server.

4. The portal server of claim 3, wherein said connected user calculation module further calculates the maximum number of concurrent sessions of user sessions in said portal server.

5. The portal server of claim 4, wherein said performance requirements assessment and analysis module further comprises a session size module for calculating the average session size of user sessions connected to the portal server at any given time.

6. The portal server of claim 5, wherein said performance requirements assessment and analysis module further comprises a memory heap size calculation module for calculating the memory heap size of the portal server.

7. The portal server of claim 6, wherein said performance requirements assessment and analysis module further comprises a fixed memory calculation module for calculating fixed memory consumption in said portal server.

8. The portal server of claim 4, wherein said memory sizing module further comprises a secondary sizing factors assessment module for gathering secondary sizing factor metrics used in determining the performance metrics of said portal server.

9. The portal server of claim 7, wherein said performance requirements assessment and analysis module further comprises a portal instance calculation module for calculating the number of central processing unit instantiations in said portal server.

10. The portal server of claim 8, wherein said secondary factors sizing module further comprises a desktop channel configuration analysis module for determining the channel configuration metrics of desktops connecting to said portal server.

11. The portal server of claim 10, wherein said secondary sizing factors calculation module further comprises a memory threshold calculation module for calculating the memory threshold of said portal server substantially based on the percentage of users connected to the portal server during a peak usage period.

12. The portal server of claim 11, wherein said memory sizing module further comprises logic to generate a subset of performance test metrics for said portal server during a test performance phase of a memory usage sizing process of the memory sizing module.

13. A memory sizing unit for determining optimal memory usage in sizing the performance of a portal server, comprising:
a performance requirement assessment and analysis module for gathering performance measurement metrics to measure the optimum performance of said portal server;
a connected user calculation module for calculating the maximum number of concurrent users that may connect to the portal server;
a portal instance calculation module for calculating the number of portal instances per a central processing unit in said portal server; and
a optimal memory calculation module for calculating optimal memory usage in said portal server.

14. The memory sizing unit of claim 13, further comprising a session size calculation module for calculating the average session size of connected users in said portal server.

15. The memory sizing unit of claim 14, further comprising a fixed memory calculation module for calculating fixed memory size of applications residing in said portal server.

16. The memory sizing unit of claim 15, further comprising a memory heap size calculation module for calculating the memory heap size of said portal server.

17. The memory sizing unit of claim 16, further comprising a secondary sizing factors assessment module for gathering secondary sizing factor metrics used in determining the performance metrics of said portal server.

18. The memory sizing unit of claim 17, wherein said secondary sizing factors module comprises a desktop channel configuration analysis module for determining channel configuration metrics of desktops connecting to said portal server.

19. The memory sizing unit of claim 18, wherein said secondary sizing factors module further comprises a memory threshold calculation module to calculating the memory threshold of said portal server.

20. A method of sizing the optimal number of memory usage size in a portal server, comprising:
determining the maximum number of connected users that may connect to said portal server;
determining the memory heap size of said portal server;
determining the number of portal instances per central processing units in said portal server;
determining the session size of said maximum connected users;
determining the fixed memory consumers and a corresponding fixed memory size of applications residing in said portal server; and
determining an optimal amount of memory required by said portal server.

21. The method of claim 20, further comprising a first multiplication step of multiplying said maximum number of connected users by said session size.

22. The method of claim 21, further comprising adding said first multiplication to said fixed memory size.

23. The method of claim 21, further comprising a second multiplication step of multiplying said maximum number of desktop displays with said reference time period to determine said optimal amount of memory in said portal server.

24. A method of determining the optimal number of central processing unit using a memory usage sizing process in a portal server, comprising:
determining the memory heap size of said portal server;
determining the memory threshold of said portal server;
determining the average portal session of users connected to said portal server;
determining the number of portal instances per a central processing unit in said portal server; and
determining the optimal number of central processing units in said portal server.

25. The method of claim 24, further comprising multiplying said memory heap by said memory threshold. determining a first quotient by dividing said average portal sessions dividing said second quotient determining step by the result of said third multiplication step.

26. The method of claim 25, further comprising determining a first quotient by dividing said multiplying said memory heap by said memory threshold by said portal session.

27. The method of claim 26, further comprising determining a second quotient by dividing said first quotient by said number of portal instances.

28. The method of claim 27, further comprising determining a third quotient by dividing said second quotient by said maximum number of connected users to determine the optimal number of central processing units in said portal server.
